(19) United States
(12) Patent Application Publication
(10) Pub. No.: US 2018/0253579 A1
(43) Pub. Date: Sep. 6, 2018

(54) SIMPLE BARCODE SYSTEM AND BARCODE

(71) Applicant: BIBO BARMAID LLC, Clinton, NJ (US)

(72) Inventor: Pak Keung WU, Kowloon (HK)

(21) Appl. No.: 15/449,949

(22) Filed: Mar. 4, 2017

(51) Int. Cl. G06K 7/14; G06K 7/10; G06K 19/06

(52) U.S. Cl. CPC G06K 7/1439; G06K 19/0614; G06K 7/10841

(57) ABSTRACT

A simple color barcode reader for reading a target color includes a PCB and a means for determining the color of the target color. The PCB has at least one R/G/B LED and photosensor installed thereon for shining light on the target color in an environment to determine the color of the target color. The means for determining the color of the target color is based upon the output from the R/G/B LED and photosensor. The target color is one of 9 natural colors as defined on the hue scale.

### CROSS-REFERENCE TO RELATED APPLICATION

This application claims priority to U.S. Provisional Application No. 62/303,710, filed on Mar. 4, 2016, the disclosure of which is incorporated herein by reference in its entirety.

### FIELD

The examples described herein relate to a barcode system. In particular, the examples described herein relate to a simple barcode system that can be utilized to read a simple barcode on packaging.

### BACKGROUND

Many consumers enjoy trying different alcoholic beverages. Often, in order to try multiple types of beverages, it is necessary to purchase a multitude of ingredients and multiple bottles of alcohol. This is often very costly and requires a significant amount of storage, since bottle are often not emptied and need to be stored. Because of this, consumers tend to stick with a certain type of drink. Countertop coffee makers have become very popular among consumers. These countertop coffee makers include a brewer which heats water from a reservoir and inputs hot water to a single serve cartridge that houses coffee grinds and a filter. Coffee is “brewed” in the cartridge and then permitted to exit the brewer into a cup. Existing machines of this nature use a traditional barcode to prevent others from selling and using non-branded cups in the machine. Traditional one dimensional or two-dimensional barcodes require an expensive reader, which is not cost effective in connection with many consumer products. Barcodes are useful in the context of consumer products for several reasons, which will be discussed in greater detail below. However, to this point, traditional barcode readers are not cost effective in most contexts.

### SUMMARY

A barcode system is shown and described. A barcode system for use with a beverage dispenser is also shown and described.

### BRIEF DESCRIPTION OF THE DRAWINGS

FIG. 1 depicts a perspective view of an example beverage dispenser that can derive a benefit from an example simple barcode reader and system according to the invention;

FIG. 2 depicts a side cross-sectional view of the beverage dispenser of FIG. 1 that incorporates an example simple barcode reader and system;

FIG. 3 depicts a side cross-sectional view of the beverage dispenser of FIG. 1 when the simple barcode reader and system are ready to read a barcode;

FIG. 4 depicts an exploded view of the simple barcode reader system for installation on part of the housing of the beverage dispenser;

FIG. 5 depicts a top view of the parts of FIG. 4 in an installed position;

FIG. 6 depicts a front view of the parts of FIG. 4 in an installed position;

FIG. 7 depicts a side view of the parts of FIG. 4 in an installed position;

FIG. 8 depicts an enlarged view of the parts of FIG. 4; and

FIG. 9 depicts a front view of a pouch incorporating a barcode according to the invention.

FIG. 10 depicts a front view of a PCB board used with the example reader system, like that shown in FIGS. 6 and 8;

FIG. 11 depicts a front view of a sensor bracket for use with the PCB board of FIG. 10;

FIG. 12 depicts a front view of an alternative PCB board that can use used with the example reader system; and

FIG. 13 depicts a front view of a sensor bracket for use with the PCB board of FIG. 12.

### DETAILED DESCRIPTION

The present disclosure is directed to an example simple barcode system that can be used in many different applications, but has been found to be useful in connection with a beverage machine in order to permit reading of pouches that are inserted into the beverage machine instead of using traditional barcodes. The hardware associated with the example system is cost effective and significantly lower in price than a traditional barcode reader. As such, it is practical for inclusion in consumer products and permits said products to be kept at a reasonable price point. While the example barcode system is described herein in the context of beverage pouches and a beverage dispenser, it should be readily recognized by those skilled in the art that other industries and products could derive a benefit from the invention. Therefore, this disclosure is meant to encompass other types of products that may utilize the example simple barcode system.

Consumers enjoy trying mixed drinks. Drink specialty menus are very popular at most restaurants. However, specialty drinks are often expensive to purchase. Consumers often would like to try specialty drinks at home, but it can be costly to purchase all the ingredients. In addition, consumers need to find recipes on their own. The beverage machine described herein provides a solution for consumers to be able to make many different kind of mixed drinks, including specialty drinks, without having to find a recipe and mix various ingredients together. The example dispenser 10 described herein allows a consumer to make a “perfect” drink every time without having to buy multiple bottles of ingredients and alcohol.

The dispenser 10 utilizes pouches of liquid to make cocktails. These pouches can hold either a liquid, a slurry, or some other type of product. Types of liquids includes juices, waters, concentrates, alcohols, a syrup, and liquors, among other types of liquids that may or may not have different viscosities. As discussed below, the beverage dispenser is designed to accept two pouches—a first having a mixer component and a second having an alcohol component. The example simple barcode reader and system may be utilized to read a simple barcode on the packaging to determine any number of things, including:

1) what type of ingredients are inside the pouch;

2) whether an appropriate combination of ingredients is positioned in the receptacles;

3) what type of pouch should be inserted in the second slot if a single pouch is inserted in the first slot;

4) how much water to add to the combination of pouches, and

5) other criteria as desired.

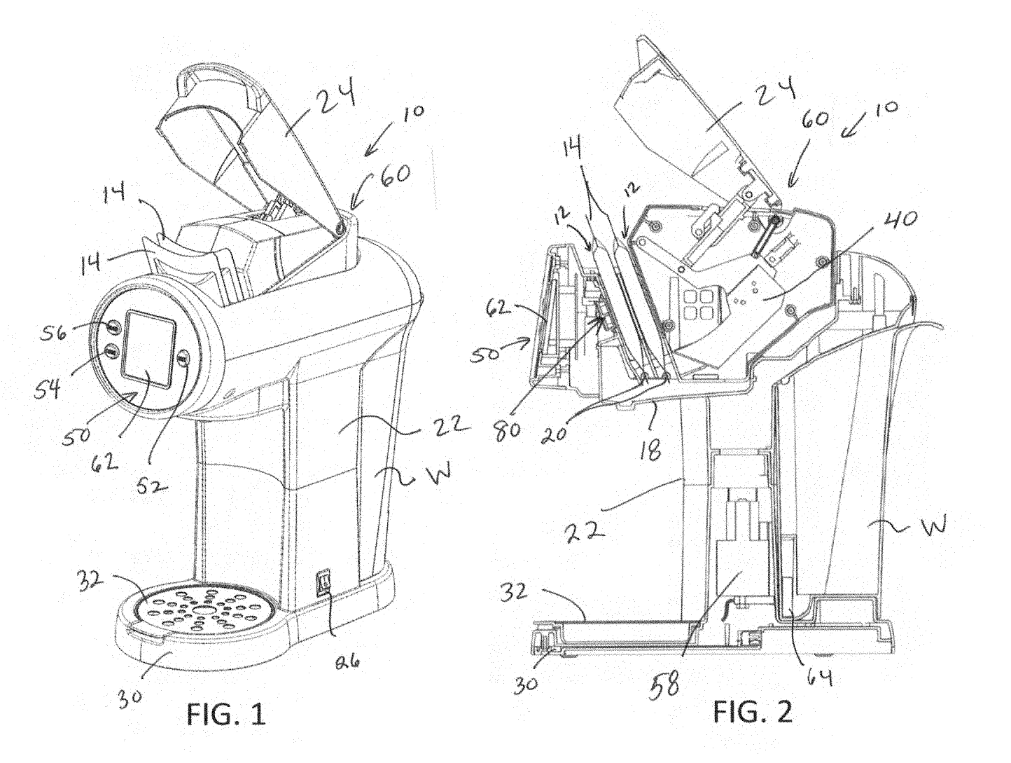

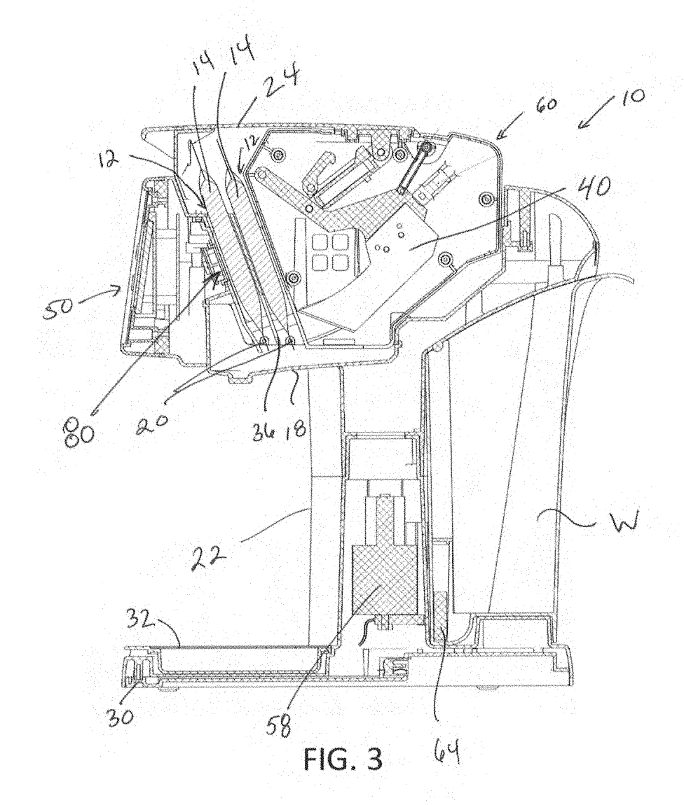

FIGS. 1-3 depict a beverage dispenser 10 that is used to make a beverage, such as a mixed drink, a mocktail, a coffee drink or another type of drink, including health drinks. The device 10 is an on-the-counter machine targeted to the casual cocktail market for people who want to try a variety of drinks, but don't necessarily want to invest in large amounts of expensive ingredients. In this example, the machine 10 is single-serve and permits a consumer to mix a wide variety of ingredients together to make a cocktail. The machine 10 depicted has two receptacles 12 for receiving ingredient containers 14, as well as a reservoir W for holding water. (More receptacles could be provided if desired). The receptacles 12 are configured to accept single serve containers 14 in the form or pouches that include liquid ingredients. Alternatively, the reservoirs could be a reservoir that holds and accepts a liquid, either for a single serve use or for multiple servings.

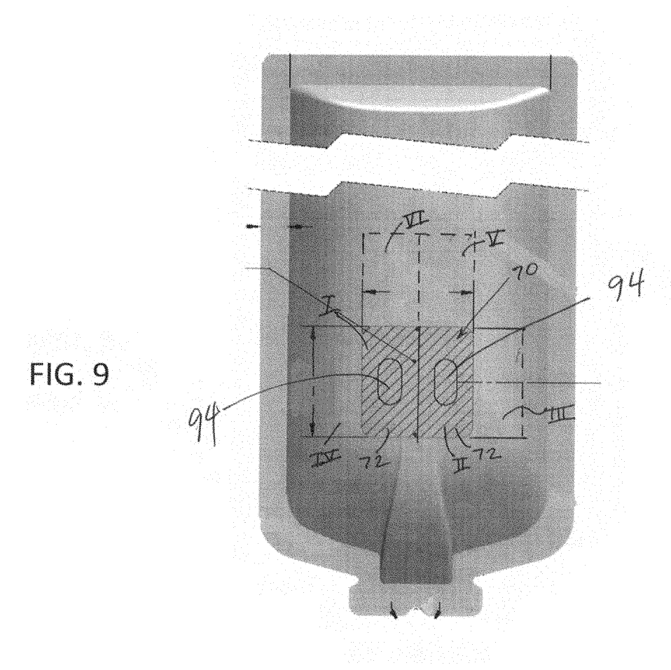

As is evident, other shapes and sizes of containers could be used, if desired. The machine could be designed to accept other types of containers, including those shaped like cups. The containers depicted in FIGS. 1-3, and also in FIG. 9, are shown as being in pouch form and have a thin wall that is conducive to slicing. Alternatively, the containers 14 could hold powder or semi-solid ingredients and having a different opening mechanism.

By utilizing receptacles 12, the consumer has the ability to create hundreds of cocktails. The containers 14 may include cocktail mixers (such as juice and other ingredients) or alcohol products (such as vodka, gin, whiskey, and the like). A typical cocktail can be made using one alcohol pouch and one mixer pouch. The containers 14 are input separately into the receptacles 12 in the dispensing machine 10 and the alcohol is typically not mixed with the mixers prior to activation of the machine 10, although there may be some formulations where alcohol is mixed with a mixer in the container 14. The size of the containers may vary relative to that shown.

The receptacles 12 could be configured to hold an ingredient, such as a liquid, syrup, powder, slurry, or other ingredient. In one embodiment, one receptacle 12 may receive a container 14 while the other accepts an ingredient (without a container). When the term container 14 is used herein, it should be understood that the term container may alternatively refer to a receptacle that holds an ingredient, without a housing of the container 14 being required.

The containers 14 are formulated so that they allow the consumer to make the “perfect” drink every time because the mixers are proportioned to exactly match the amount of alcohol in the alcohol container 14. This allows the consumer great ease to try a variety of drinks, mixed perfectly, in their own home. No measuring of ingredients is needed. The consumer only has to insert the containers 14 into the receptacles 12 and let the machine 10 prepare the cocktail.

The Alcohol and Tobacco Tax and Trade Bureau (TTB) regulates the labeling, advertising and marketing of alcoholic beverages in the United States. Wine and liquor may only be sold in standard sizes. Some jurisdictions provide different rules depending on the strength of the alcohol. The smallest size bottle of distilled spirits permitted to be sold in the United States is referred to as a miniature and has a size of 50 ml or 1.7 ounces. A typical shot that is dispensed in US bars is between 1 ounce and 1.5 ounces. The “shot” dispensed in connection with the subject dispenser 10 is 1.7 ounces in order to conform to US sizing standards. This may change over time if federal regulations change. Other countries may have different requirements and the example pouches can be modified based upon jurisdictional requirements. The mixers utilized with the dispensing device 10 are formulated for use with 1.7 ounces of spirits. If a different size “shot” is permitted to be sold, then the mixers can be adjusted based upon the quantity of alcohol in the “shot” container. Double shots of alcohol may be used by either using a larger container 14 in the receptacle 12 or by using two alcohol containers 14, each having 1.7 ounces of alcohol. In one example, the dispenser 10 may have the capacity to make a “double” so that 3 ounces of alcohol are used at minimum, along with about 8 oz. of mixer. Alcohol may be dispensed as a precisely measured mixologist bartender shot, if desired and permitted under local laws.

The dispenser 10 of FIGS. 1-3 includes a housing 22, a water reservoir W, a cover 24, multiple receptacles 12 for receiving containers 14, a cutter assembly 60, a display panel 50, an on/off switch 26, and a catch tray 30. The catch tray 30 may include a liner 32. The display panel 50 includes an LED screen 62 that may be back lit. The display panel 50, as shown, includes a “mix” button 52, a “clean” button 54, and a “read” button 56. Other buttons may also be provided. Other configurations of buttons for the machine 10 may be utilized.

The containers 14, as shown, are pouch-shaped and are inserted substantially vertically into receptacles 12. The receptacles 12 are angled forwardly so that the pouches will rest against a forward surface. In one embodiment, the containers 14 rest at an approximately 20 degree angle. The angle of inclination may range from about 10 degrees to about 60 degrees, including 20 degrees, 30 degrees, 40 degrees, and 50 degrees, as well as intervals therebetween. The receptacles are positioned in front of a cutting assembly 60 that is used to cut the pouches open utilizing a blade 40. A divider 36 may be positioned in the receptacles to provide two separate receptacles 12.

A water reservoir W is positioned on a rear end of the housing. A pump 58 is coupled to the water reservoir W and is used to pump water through the housing 22 to mix the water with ingredients stored in the containers 14. The water reservoir W is removable to permit refilling of the reservoir with water. The water reservoir W may have a switch that is coupled to a float 64 that signals to the user that the reservoir W is low on water.

The example drink dispenser 10 takes multiple containers 14 of ingredients, adds water and dispenses them into a cup 16. A funnel 18 or reservoir is positioned below the receptacles 12 and serves as a mixing chamber for the ingredients in the containers 14, as well as a station for mixing water with the contents of the containers 14. Water nozzles or outlets 20 are provided at the bottom of the receptacles 12 or otherwise associated with the funnel 18. The water outlets 20 are coupled to the pump 58 and the water reservoir W and are used to mix water with the contents of the containers 14.

As discussed above, the display 50 includes a button for “mix” 52 and “clean” 54. The “mix” button 53 is pressed after the cover 24 is closed to dispense water from the water reservoir W. The “mix” button 52 is tied to a control system that will meter an appropriate amount of water for the particular containers 14 used. The mix button 52 may also be tied to a read function 56 such that upon reading the type of container 14 used, the control system can determine how much water to add. The “mix” button could be removed such that the pump starts the flow of water as soon as the cover is closed and reading occurs automatically. Regardless, reading of the barcode can occur automatically or upon selection by a user.

The “clean” button 54 is pressed when no containers 14 are present in the receptacles 12 to rinse or clean the interior of the device with water. In addition, the cutter assembly 60 and divider plate 36 may be removable from the housing 22 to permit a user to easily clean the internal parts of the device 10 that come into contact with ingredients.

The simple barcode 70 is shown on the packaging, which is a pouch, in FIG. 9. As shown, the simple barcode includes two blocks 72 of color. The blocks 72 may be rectangular or another shape, as long as they are large enough to be read by the reader to determine what color they are. Two rectangles of color I, II are shown in FIG. 9, but other boxes may also be added to the color code. For example, three rectangles I, II, III, four rectangles, I, II, III, IV, five rectangles I, II, III, IV, V or six rectangles, I, II, III, IV, V, VI could be used. The rectangles can be boxes of any shape, including round, oval, or part of an overall picture. As is shown, the boxes can be formed in a 2×1 array, a 2×2 array, a 3×1 array, a 4×1 array, or another array. The color boxes together form the example barcode according to the invention. Each color box can be the same or a different color, as selected from nine “natural” colors on the hue scale that include black, white, red, green, blue, yellow, orange, purple, and pink. Thus, a 2×1 array will provide 81 combinations (9×9), a 3×1 array will provide 729 options (9×9×9), a 4×1 array will provide 6561 options (9×9×9×9). Where a limited number of choices is needed, a single box I can be used to provide 9 options. Thus, the system is scalable upwardly based upon the number of color boxes provided.

A size for two boxes of the barcode is around 10×10 mm or 15×15 mm. In another embodiment, the size may be 29 mm×29 mm. The actual reading area on the barcode is shown by the oval areas 94 on the barcode. The greatest read power is provided within the encircled areas, but a greater surface area of color is shown around the read areas to provide for variations in placement and insertion of the pouch into the device 10.

The color boxes may be positioned at any position on the respective containers, as long as they align with a barcode reader that is associated with the system.

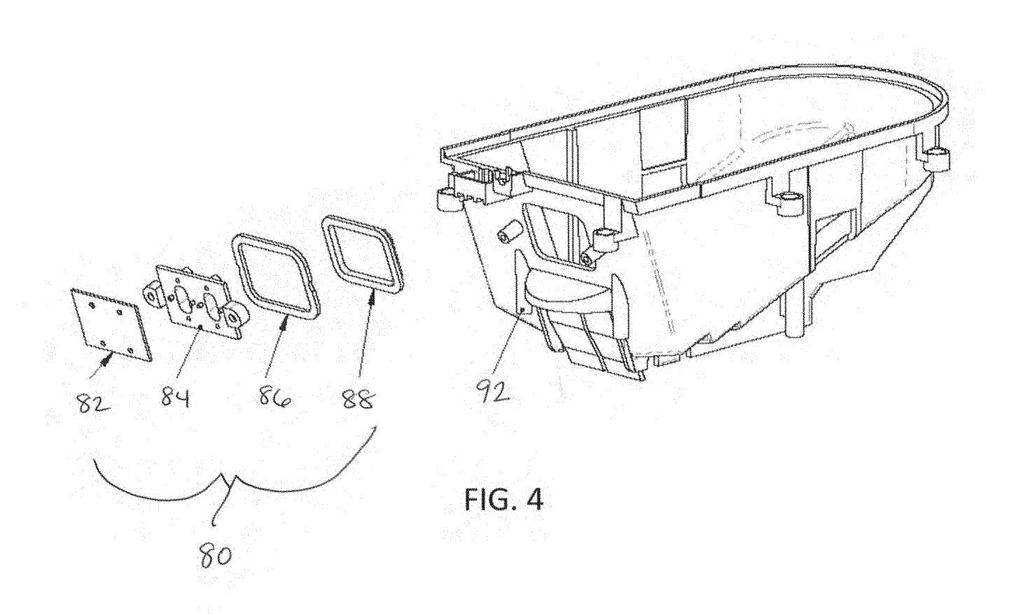

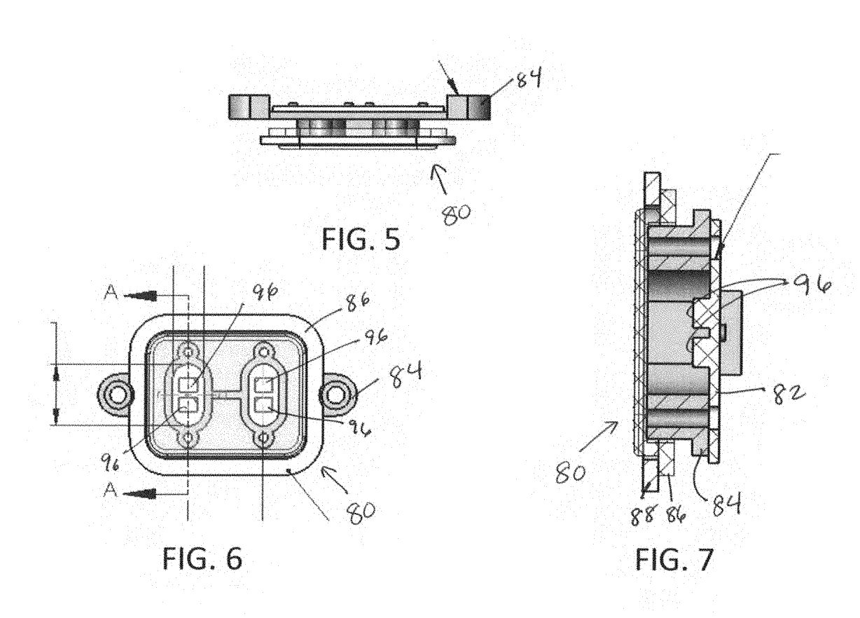

A barcode reader 80 is installed in the housing 22 of the device 10 to read the barcode from the pouch. FIGS. 2-4 show the location of the barcode reader 80 as being positioned directly in front of the cutting assembly basket 92. The barcode reader of the invention involves the use of an R/G/B LED to shine on the barcode to receive monochrome data (which may be 8-bit data). The system allows for a wide tolerance of colors and printing of the color codes while still providing an accurate result, in contrast to prior systems that required a very accurate value for the color, and thus, tight calibration. The system reads the color and classifies it as one of nine natural colors. This permits for wide variation in the color that is printed. For example, red can be red, deep red, and light red. Blue can be light blue, dark blue, navy blue, and royal blue. The system typically does not read brown or grey. Brown will be read as orange and grey may be read as blue or black.

The barcode reader includes a PC Board 82 that includes an R/G/B LED and a reader chip, a reader mount 84, a lens gasket 86, and a reader lens 88. The combination of parts forms the barcode reader 80. The barcode reader 80 is attached to the cutter assembly basket 92 by screws or other means. The example system works best in a dark environment. This is provided with the beverage dispenser because the pouches 14 rest directly against the reader lens 88 when they are inserted properly into the forward-most receptacle 12. In addition, a gasket 86 around the reader 80 helps to keep light from entering through the sides of the reader 80. If the environment is not dark, the reader 80 may not work as required. The reader lens helps to protect the PC Board from exposure to fluids. In order to add greater reading capability, a Y may be added to the R/G/B LED to produce an R/G/BY LED.

The angle of the receptacle 12 also helps to align the pouch 14 against the reader lens 88. The pouch 14 will lie against the lens 88 because it leans on the lens 88. In contrast, if the pouch 14 is completely vertical, the receptacle 12 would have to more tightly fit the pouch to ensure that the barcode 70 is pressed against the reader lens 88 so that no light enters from the receptacle 12. If the environment adjacent the pouch 14 is already substantially dark, then the fit of the pouch relative to the reader will matter less.

The technology includes the use of an MCU with ADC (Analog to Digital). Three outputs are used to drive 3 LEDs that include Red, Green and Blue. An ADC input is used to power the photo transistor (PT). The MCU will illuminate the R/G/B LEDs one by one. The light of the LED will shine on the barcode and the barcode color and intensity will be reflected back. The photo transistor will receive the analog reading and will convert this to a digital 8-bit value.

For example, for a white barcode color, a high light power will be reflected to the PT, so the analog reading will be high (PT has lower resistance if the light is bright). In this case, the 8-bit value will be as high as 235 or more (8 bit is 0-255). For a black color code, less light power will be reflected back to the PT and the analog reading will be low (PT has high resistance if light is dim). In this case, the 8-bit value will be around 20 or lower.

The system assigns a color to each range of analog readings to provide for the reading of nine different natural colors. Color is read to receive an R/G/B three 8-bit value. Once the three 8-bit values are read, the Hue, Saturation, and Lightness (HSL) can be determined using a standard conversion algorithm, such as http://serenna.com/colour/hsltoR/G/B_php. Once the HSL is determined, hue can be used to determine the color.

For example, a hue of 345 degrees to 10 degrees will be red. A hue of 10 to 25 degrees will be orange, a hue of 25 to 55 degrees will be yellow, a hue of 55 to 140 degrees will be green, etc.

In the context of a beverage dispenser that handles liquids, a reader lens is useful because it can help to prevent liquid from splashing onto the PC Board. However, there is no specific construction that is required. The reader may include the reader lens, but it is not absolutely required and is dependent, in part, on the environment. However, darkness is preferred to properly read the barcode color because any light from the environment will affect the PT reading and may provide a false reading. The darkness may be checked by the PT before the color is read. If it is not dark enough, the PT will not read the color or may signal an error.

Because two color blocks are used in the example shown, two R/G/B LED sensors 96 are positioned on the PC Board. The sensors 96 are spaced apart so that they will not interfere with one another. Photosensors, such as phototransistors 104, are positioned adjacent each of the R/G/B LED sensors 96. The R/G/B LED shines known wavelengths of light on the surface of the pouch 14 to be measured by the phototransistors 104. Three separate readings are taken by the phototransistor 104 or similar device for each of the LED's different colors. Then an algorithm is used to extrapolate the R/G/B value of the surface. In addition, the reader mount 84 and lens gasket 86 help to keep the sensors 96 and phototransistors 104 from interfering with one another.

In use, the color barcode reader system may be tied to the “read” button 56. The read button 56 is used to read the color barcodes on the pouches 14. Once the color is known, the computer program can look up the colors from a table that is programmed into the software to determine what type of pouches are inserted. Then the software can use this information to determine whether a proper combination of containers 14 is installed and, if so, how much water to add. The software can also display messages on the screen of the display based upon the information obtained from reading the barcodes. The device 10 may include a processor and/or controller, as well as any other hardware or software necessary for proper operation of the device, as known by those of skill in the art.

As mentioned, the environment should be dark and no natural light should enter the reader for the system to work properly. The example barcode system provides an efficient and inexpensive solution for barcodes in consumer products.

Based upon the reading of the barcode color, the computer programming will determine an appropriate amount of water to add and the pump 58 will meter out an appropriate amount of water to coincide with the ingredients in the containers 14 to make a cocktail.

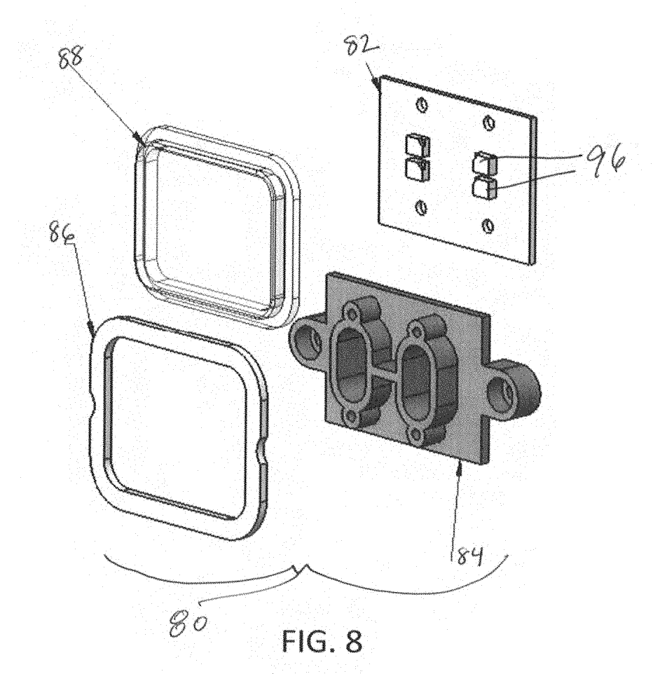

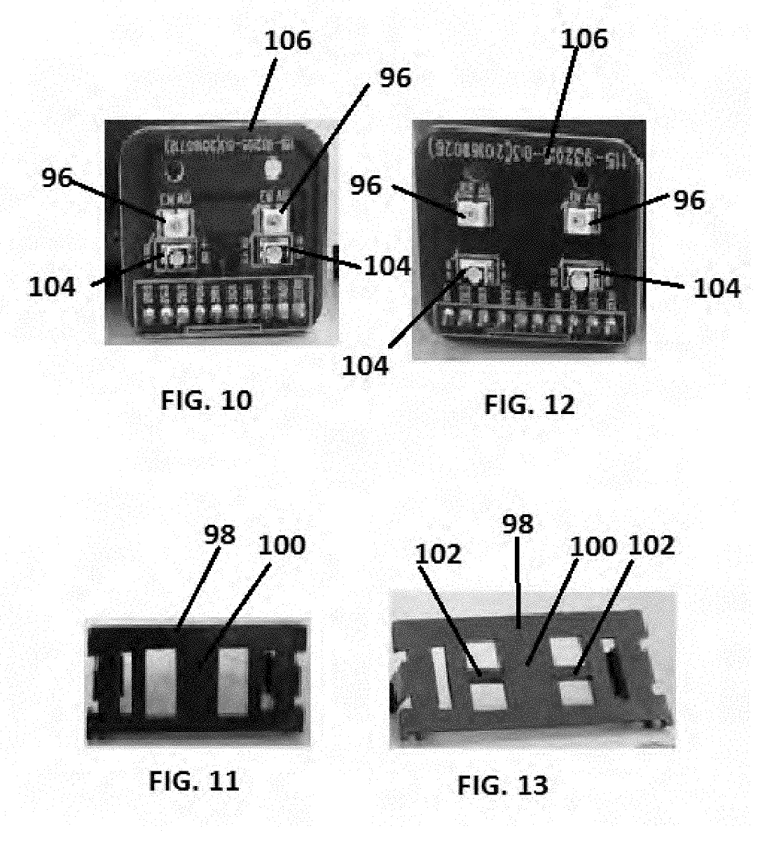

FIGS. 10 and 11 depict a PCB board 106 similar to that shown in FIG. 8. The R/G/B LED sensors 96 are shown positioned on a left side and a right side of the PCB board 106. The two sensors 96 on the left side are used to read a color on the respective side and the two sensors 96 on the right side are used to read a color on the other side of a pouch 14. The sensors 96 are shown positioned relatively closely together. FIG. 11 depicts a sensor window 98 that serves as a screen to help to avoid reflection between the sensors 96 on the left side and sensors 96 on the right side. This is desirable because it helps the system to read colors properly. The sensor window 98 has a rib 100 that extends down the middle of the sensor pairs 96 between the left side sensors 96 and the right-side sensors 96. The window 98 also encircles the groupings of sensors 96 to deter internal reflection around the sides of the sensors 96.

FIGS. 12 and 13 are similar to the parts shown in FIGS. 10 and 11, but provide additional protection against internal reflection. FIG. 12 depicts a PCB board 106 that has four sensors 96 that are spaced out relative to the design shown in FIG. 10. By spacing the sensors 96 out, internal reflection is further reduced by using a sensor window 98 such as shown in FIG. 13. The sensor window of FIG. 13 has both a horizontal rib 102 and a vertical rib 100 so that all of the sensors 96 are boxed in. This provides additional protection against internal reflection.

The containers 14 can be made of PET, Polypropylene, Polystyrene, PETG, Surlyn, and HDPE food-grade materials or other materials. The containers 14 may also include foil or other laminations, including any number of polymeric materials or combinations of materials in layers. The liner or containers 14 may comprise a combination of materials in layers, or could be a non-foil seal.

While not shown, four pouches 14 could be utilized instead of two, with two pouches being stacked on top of each other in each receptacle 12. In this case, the receptacles would need to be large enough to accommodate two pouches, or the pouches would need to be small enough to fit in a single receptacle 12. The cutting blade 40 would need to be long enough and sturdy enough to puncture all containers 14 in the receptacles.

The container 14 sizes and shapes may vary from that shown here and relative to one another in use. One possible size for a large pouch is a capacity of 6-8 oz. Another pouch or container may have a size of 1-2 ounces. The pouches or containers 14 may hold concentrated ingredients. As such, the size of the pouches or containers 14 may be reduced. For example, a 2-ounce pouch of orange juice concentrate may make 8 ounces of juice when properly re-constituted. Examples of types of components that may be used in making a cocktail using the device 10 include the following, which represent different viscosities: syrup, alcohol, juice/juice puree, dairy, flavored water, a combination thereof, or other components not mentioned.

Other features such as refrigeration, ice dispensation, and carbonation may be utilized with the device disclosed herein. For example, a separate container 14 may be added to the first and second containers 14 to provide a carbonating component. Alternatively, a separate carbonation system may be utilized along with flavoring and alcohol containers 14. A CO₂ container may be used for purposes of carbonation, if desired. Ice dispensing may be provided by an auxiliary device (not shown) that is either integral with or separate from the device 10. The device 10 may include a refrigeration component (not shown) to chill or cool the components rapidly during the dispensing process. The device 10 may include a sensory signal to indicate that the products are being mixed together during dispensation. Although an initial embodiment of the beverage maker 10 is an on-the-counter device, the device 10 may alternatively be an on-the-floor device or have different sizes depending upon the application.

The dispenser 10 may be used to make any number of different types of cocktails. Examples of types of cocktails include those presented at http://www.drinksmixer.com/cat/1/(12000+cocktail recipes). As an example, one type of cocktail that may be made with the device 10 is “Sex on the Beach,” a popular fruit mixed drink made of vodka, peach schnapps, creme de cassis, and orange and cranberry juices. An individual container 14 for “Sex on the Beach” may be input to the system as well as a “shot” container 14 that includes a combination of vodka, peach schnapps and créme de cassis. Alternatively, the “Sex on the Beach” container 14 may already include all the components with the exception of vodka, which may be input using a separate shot container 14 or by pouring it into a receptacle or the glass.

Alternatively, separate receptacles 12 for receiving multiple components may be used, or containers 14 may be sized to seat on top of or stacked against each other, with the cutting blade 40 slicing through all containers 14 in the receptacle 12 to permit the contents of the containers 14 to be evacuated. For example, a single receptacle 12 could house the “Sex on the Beach” non-alcoholic components while a second single receptacle 12 could house the alcohol components including a peach schnapps container 14, a créme de cassis container 14, and a vodka container 14. The alcohol components could be stacked on top of each other or otherwise arranged in the receptacle 12. The alcohol components could be the same size or different sizes, depending upon what is called for in the drink recipe.

The dispensing device 10 may alternatively be used to make health drinks, such as those that include nutritional supplements or other “health food” related components. One type of ingredient may be a mixture of vitamins in a concentrated liquid form, which are known to be more readily absorbed by the body. Alternatively, a powder-based mix may be used, with water from a water supply W being used to make the mixture flow through the system 10. Other types of health enhancing products may be used including vitamins, minerals, and other nutrients or products, as known by those of skill in the art. Pureed fruits and vegetables may be utilized to incorporate fruits and vegetables, if desired. For example, a kale-based container 14 could be used along with a mango-based container 14 along with a supplement container 14. Juices may be used. This permits the user to customize their “health” drink to find a drink mixture that they enjoy.

In one embodiment, a simple color barcode reader for reading a target color includes a PCB 106 having at least one R/G/B LED and photosensor installed thereon and means for determining the target color based upon the output from the R/G/B LED and photosensor, wherein the R/G/B LED and photosensor shine light on the target color in an environment to determine the color of the target color. The target color is one of 9 natural colors as defined on the hue scale. The 9 natural colors include black, white, red, green, blue, yellow, orange, purple and pink.

The barcode reader may also include a reader mount for coupling the reader to a device, a lens gasket, and a reader lens. The barcode reader may also include a sensor window positioned adjacent the R/G/B LED and phototransistor to deter internal reflection between the various parts. The reader mount may serve the function of the sensor window. The sensor window may have a rib positioned between the R/G/B LED and the photosensor to further deter internal reflection.

The means for determining the color of the target based upon the output from the R/G/B LED and phototransistor is an algorithm. The photosensor receives an 8-bit value for each R/G/B led and the 8-bit values are corrected using a standard conversion algorithm to determine a hue of the target. The environment may be dark.

Two R/G/B LED's may be provided and two photosensors may be provided, with one of each R/G/B LED and photosensor being positioned on a first side of the PCB 106 and one of each R/G/B LED and photosensor being positioned on a second side of the PCB 106. A sensor window may also be provided mounted over the PCB 106 and R/G/B LED and phototransistors, with the sensor window having ribs that extend between each of the R/G/B LED and photosensors to box them in and deter internal reflection. The photosensor may be a phototransistor.

In another embodiment, a barcode reader system includes an environment that is dark, a color target, and a reader. The reader includes an R/G/B led and photosensor. The R/G/B LED shines a light on the color target and the photosensor reads R/G/B values, which are converted to hue to determine which of 9 natural colors is present in the color target.

The color target may include a first color target and a second color target. The reader may include a first R/G/B LED and a first photosensor and a second R/G/B LED and a second photosensor. The first R/G/B LED and the first photosensor may read the color of the first color target, and the second R/G/B LED and the second photosensor may read the color of the second color target. A conversion algorithm may be utilized to convert the R/G/B values into a hue.

The first and second color targets may be isolated from one another. The first and second color targets may be positioned adjacent one another.

In another embodiment, a drink dispenser includes a receptacle, a barcode reader, and a computer program. The receptacle is defined in the drink dispenser for receiving a container having a color block disposed on an exterior surface of the container. The barcode reader is coupled to the receptacle for reading a color of the color block, with the barcode reader including a PCB 106 having an R/G/B LED and a photosensor installed thereon. The computer program is associated with the drink dispenser for converting readings from the photosensor into a color using a conversion algorithm.

The barcode reader may include a reader mount for coupling the reader to the drink dispenser and a lens gasket for blocking out external light. The barcode reader may include a sensor window positioned over the PCB 106 that provides a window for the R/G/B LED and the photosensor to avoid internal reflection.

The term “substantially,” if used herein, is a term of estimation. While the above described drink dispenser 10 is described in the context of cold drinks, it could also apply to hot drinks.

While various features of the claimed invention are presented above, it should be understood that the features may be used singly or in any combination thereof. Therefore, the claimed invention is not to be limited to only the specific embodiments depicted herein.

Further, it should be understood that variations and modifications may occur to those skilled in the art to which the claimed invention pertains. The embodiments described herein are exemplary of the claimed invention. The disclosure may enable those skilled in the art to make and use embodiments having alternative elements that likewise correspond to the elements of the invention recited in the claims. The intended scope of the invention may thus include other embodiments that do not differ or that insubstantially differ from the literal language of the claims. The scope of the present invention is accordingly defined as set forth in the appended claims.

What is claimed is:

1. A simple color barcode reader for reading a target color comprising:
a PCB having at least one R/G/B LED and photosensor installed thereon for shining light on the target color in an environment to determine the color of the target color; and
means for determining the color of the target based upon the output from the R/G/B LED and photosensor, wherein the target color is one of 9 natural colors as defined on the hue scale.

2. The barcode reader of claim 1, wherein the 9 natural colors include black, white, red, green, blue, yellow, orange, purple and pink.

3. The barcode reader of claim 1, further comprising a reader mount for coupling the reader to a device, a lens gasket, and a reader lens.

4. The barcode reader of claim 4, further comprising a sensor window positioned adjacent the R/G/B LED and phototransistor to deter internal reflection between the various parts.

5. The barcode reader of claim 4, wherein the reader mount serves the function of the sensor window.

6. The barcode reader of claim 4, wherein the sensor window has a rib positioned between the RGD LED and the photosensor to further deter internal reflection.

7. The barcode reader of claim 1, wherein the means for determining the color of the target based upon the output from the R/G/B LED and phototransistor is an algorithm.

8. The barcode reader of claim 1, wherein the photosensor receives an 8-bit value for each R/G/B led and the 8-bit values are corrected using a standard conversion algorithm to determine a hue of the target.

9. The barcode reader of claim 1, wherein the environment is dark.

10. The barcode reader of claim 1, wherein two R/G/B LED's are provided and two photosensors are provided, with one of each R/G/B LED and photosensor being positioned on a first side of the PCB and one of each R/G/B LED and photosensor being positioned on a second side of the PCB, and further comprising a sensor window mounted over the PCB and R/G/B LED and phototransistors, with the sensor window having ribs that extend between each of the R/G/B LED and photosensors in order to box them in and deter internal reflection.

11. The barcode reader of claim 1, wherein the photosensor is a phototransistor.

12. A barcode reader system comprising:
an environment that is dark;
a color target; and
a reader that includes an R/G/B led and photosensor, wherein the R/G/B LED shines a light on the color target and the photosensor reads R/G/B values, which are converted to hue to determine which of 9 natural colors is present in the color target.

13. The barcode reader system of claim 12, wherein the color target includes a first color target and a second color target, and the reader includes a first R/G/B LED and a first photosensor and a second R/G/B LED and a second photosensor, and the first R/G/B LED and the first photosensor read the color of the first color target, and the second R/G/B LED and the second photosensor read the color of the second color target, wherein the first and second color targets are isolated from one another.

14. The barcode reader system of claim 13, wherein the first and second color targets are positioned adjacent one another.

15. The barcode reader system of claim 12, further comprising a conversion algorithm for converting the R/G/B values into a hue.

16. A drink dispenser comprising:
a receptacle defined in the drink dispenser for receiving a container having a color block disposed on an exterior surface of the container;
a barcode reader coupled to the receptacle for reading a color of the color block, with the barcode reader including a PCB having an R/G/B LED and a photosensor installed thereon; and
a computer program associated with the drink dispenser for converting readings from the photosensor into a color using a conversion algorithm.

17. The drink dispenser of claim 16, wherein the barcode reader further comprises a reader mount for coupling the reader to the drink dispenser and a lens gasket for blocking out external light.

18. The drink dispenser of claim 17, further comprising a sensor window positioned over the PCB and providing a window for the R/G/B LED and the photosensor to avoid internal reflection.
